(19) United States
(12) Patent Application Publication
(10) Pub. No.: US 2023/0240426 A1
(43) Pub. Date: Aug. 3, 2023

(54) ADHESIVE GEL NAIL AND MANUFACTURING METHOD THEREOF

(71) Applicant: SUNWOO INDUSTRIES, Incheon (KR)

(72) Inventor: Sung Ju HAN, Incheon (KR)

(73) Assignee: SUNWOO INDUSTRIES, Incheon (KR)

(21) Appl. No.: 18/008,660

(22) PCT Filed: Aug. 31, 2021
(86) PCT No.: PCT/KR2021/011639

§ 371 Date: Dec. 6, 2022

(30) Foreign Application Priority Data
Oct. 23, 2020 (KR) 10-2020-0138470

(51) Int. Cl. A45D 31/00; A45D 29/00; B32B 7/12; B32B 27/08

(52) U.S. Cl. CPC A45D 31/00; A45D 29/001; B32B 7/12; B32B 27/08

(57) ABSTRACT

An adhesive gel nail for remarkably increasing colorability, durability and permeability, and a manufacturing method thereof are provided, wherein the adhesive gel nail according to one aspect of the present invention includes: an adhesive layer; a color base layer formed on the adhesive layer; and a colored layer formed on the color base layer.

### TECHNICAL FIELD

The present invention relates to an adhesive gel nail and a manufacturing method thereof, and relates to an adhesive gel nail with remarkably improved wearing comfort and colorability, and a method for manufacturing the same.

### BACKGROUND ART

In general, a nail art has been done by applying pigments such as nail polish of various colors to fingernail or toenail, or attaching accessories such as beads or jewelry to fingernail.

However, this method of applying liquid pigments to the fingernail or the toenail may cause inconvenience to users because it takes a lot of time to cure after applying the pigment. Also, even when attaching an accessory, it takes time for the adhesive to completely solidify, and there was a problem that the accessory could easily fall off with a small impact even after attachment was completed.

In order to solve these problems, a method of attaching a nail sticker is used instead of a method of directly applying a pigment to a user's fingernail or toenail. According to this method, the user can decorate the fingernail and toenail simply by attaching a sticker to the fingernail or toenail without having to wait until the pigment is applied and cured, so the user can perform the nail art much more quickly and easily compared to the conventional method.

Furthermore, as disclosed in Prior Art Documents 1 to 4, a method for maintaining the shape attached to the fingernail or toenail by performing UV curing after attaching a soft, semi-solid sticker to the nail or toenail has recently been proposed.

However, in Prior Art Documents 1 to 4, there is a problem of implementing a color layer on an adhesive layer or an adhesive layer. In other words, the color layer in the gel nail plays an important role in determining the color of the gel nail sticker, and in Prior Art Documents 1 to 4, the color layer is formed directly on the adhesive layer or the adhesive layer, so the problem of poor coloring occurs.

Also, if the color layer is cured later due to the adhesive layer or the soft nature of the adhesive layer, it also causes a problem where cracks occur. Accordingly, Prior Art Document 5 discloses the gel nail sticker that prevents the color layer from being cured by ultraviolet rays. However, in order to prevent curing, a light stabilizer must be separately used in the process of forming the color layer, so the problem of increasing manufacturing costs also occurs.

Also, when the nail sticker is attached for a long time, oxygen cannot be supplied for a long time, and nail health may be harmed, so improvement of adhesives or adhesives is also required.

[symbol]

### PRIOR ART DOCUMENTS

### Patent Documents

(Patent Document 1) Korean Registration Patent No. 10-2024663 (2019 Sep. 24) GEL NAIL STICKER

(Patent Document 2) Korean Registration Patent No. 10-2024666 (2019 Sep. 24) GEL NAIL STICKER MANUFACTURING METHOD

(Patent Document 3) Korean Registration Patent No. 10-1949267 (2019 Feb. 19) GEL NAIL STICKER AND METHOD FOR MANUFACTURING THE SAME

(Patent Document 4) Korean Registration Patent No. 10-1797203 (2017 Nov. 15) A SEMI HARDENING GEL TYPE NAIL-STICKER FOR NAIL ART AND METHOD MAKING IT

(Patent Document 5) Korean Registration Patent No. 10-1982125 (2019 May 24) GEL NAIL STICKER AND METHOD FOR MANUFACTURING THE SAME

### DETAILED DESCRIPTION

### Technical Problem

The present invention is to solve the above problems of the prior art, and aspects of the present disclosure provide an adhesive gel nail with remarkably increased colorability or durability and a manufacturing method thereof.

Also, aspects of the present disclosure also provide an adhesive gel nail and a method for manufacturing the same, which have high air permeability and minimize the effect on fingernail or toenail.

### Technical Solution

The adhesive gel nail according to one aspect of the present invention includes an adhesive layer, a color base layer formed on the top of the adhesive layer, and a color layer formed on the top of the color base layer.

In this case, the color base layer may be formed of a urethane material.

Also, an air hole may be formed in the color base layer.

Also, the color base layer can be formed by a structure in which an open cell and a closed cell are mixed.

Also, the surface roughness of the color base layer may be smaller than that of the adhesive layer.

Also, the adhesive layer can include at least one of vitamins, calcium, eucalyptus, cypress water, and natural herbs.

Also, the color layer can be cured by the ultraviolet rays while being in contact with the color base layer.

Also, the adhesive gel nail may further include the gel coating layer formed on the color layer, and the gel coating layer may include a UV gel coating layer and an LED gel coating layer.

Meanwhile, the method for manufacturing the adhesive gel nail according to one aspect of the present invention includes forming the adhesive layer and forming the color base layer on the adhesive layer, and forming the color layer on the color base layer.

In this case, in the step of forming the color base layer, a urethane film having a surface roughness smaller than that of the adhesive layer may be attached to the adhesive layer.

### Advantageous Effects

In the adhesive gel nail and manufacturing method thereof according to the present invention, the color base increases the colorability and resolution of the color layer.

Also, since the surface roughness of the color base becomes smaller than the adhesive layer, the color base layer closely supports the color layer until the color layer is cured while increasing the printing resolution, thereby significantly increasing the durability of the color layer and the entire gel nail.

### DESCRIPTION OF DRAWINGS

FIG. 1 is a cross-sectional view of the adhesive gel nail according to one embodiment of the present invention.

FIG. 2 is a view illustrating the gel coating layer in FIG. 1 in more detail.

FIG. 3 is a flowchart illustrating a method of manufacturing the adhesive gel nail according to one embodiment of the present invention.

### MODE FOR INVENTION

Hereinafter, embodiments of the present invention will be described in detail so that a person skilled in the art can easily implement it. Since the present invention may apply various changes and have various embodiments, it will be described in detail by exemplifying specific embodiments in the drawings. However, this is not intended to limit the present invention to specific embodiments, and should be understood to include all modifications, equivalents, and substitutes included in the spirit and technical scope of the present invention.

Unless otherwise defined, all terms used herein, including technical or scientific terms, have the same meaning as commonly understood by a person skilled in the art. Terms such as those defined in commonly used dictionaries should be interpreted as having a meaning consistent with the meaning in the context of the related art, and are not interpreted as having an ideal or overly formal meaning unless clearly defined in this application.

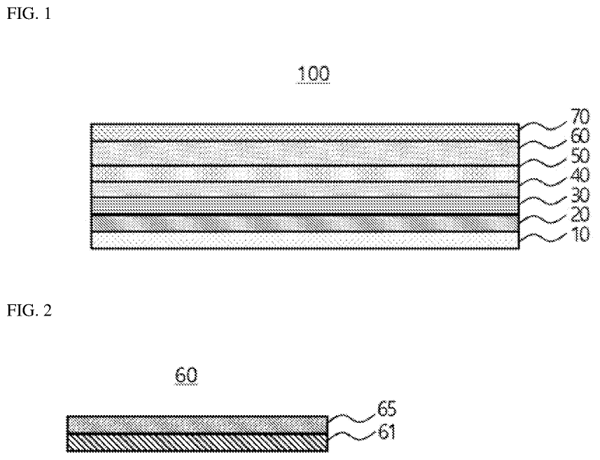

Hereinafter, the adhesive gel nail according to one embodiment of the present invention will be described. FIG. 1 is a cross-sectional view of the adhesive gel nail according to one embodiment of the present invention, and FIG. 2 is a view illustrating the gel coating layer in FIG. 1 in more detail.

Referring to FIG. 1, the adhesive gel nail (100) according to one embodiment of the present invention includes an adhesive layer (20), a color base layer (30), a color layer (40), and a gel coating layer (60). In this case, the adhesive layer (20) can be formed on the base film (10) for its manufacture, and may further include a separate printing layer (50) in addition to the color layer (40). Also, as illustrated, the protective film (70) may be added to protect the gel coating layer (60).

First, the base film (10) plays a role of supporting to form the adhesive layer (20) and may be positioned at the bottom of the adhesive gel nail (100). The base film (10) may be formed of a release paper and can be removed when using the adhesive gel nail (100). More specifically, the base film (10) may include a silicone release treatment fabric in a PET material.

The adhesive layer (20) includes at least one of the acrylic water-based adhesive, acrylic oil-based adhesive, and UV curable adhesive, and refers to a portion directly attached to a user's fingernail or toenail. This adhesive layer (20) is formed by coating on the base film (10).

The adhesive layer (20) may include a nutrient enhancing component for caring for nails and toenails and an antibacterial component for protecting nails from bacteria or mold, etc., as an anti-puncture nutritional glue layer.

More specifically, the adhesive layer (20) includes at least one of vitamins, calcium, eucalyptus, cypress water, and natural herbs. In this case, vitamin B5, vitamin E, calcium, etc. may be included as the nutrient enhancing component, and eucalyptus, cypress water, and natural herbs may be included as the antibacterial component.

That is, since the adhesive gel nail according to the present embodiment includes the nutrient enhancing component and the antibacterial component at the same time, it is possible to protect the user's fingernails and toenails damaged by frequent self-nail procedures and minimize damage to the nail surface.

The color base layer (30) is formed on the top of the adhesive layer (20), and may be formed to create the air hole by adding an aerosol to a urethane raw material. Alternatively, by using a mixture of ester polymer and ether polymer as the urethane raw material, the internal structure of the color base layer can be formed in a mixed structure of open cell and closed cell, and in order to ensure minimum air permeability, it is preferable that the volume % ratio of the open cell is formed to be 5% or more.

With such a color base layer (30), the adhesive gel nail (100) can have the air permeability due to the increased oxygen permeability, so that when a user attaches the gel nail (100) to a nail or toenail, it is possible to have a more comfortable fit without feeling stuffy. In this case, the urethane sheet layer (30) may have a thickness of 20 to 50 um.

Furthermore, the color base layer (30) may be formed in white while being positioned below the color layer (40).Therefore, in the adhesive gel nail (100) according to the present embodiment, since color inks mixed with CMYK or mixed with other colors are applied on the white color base layer (30) to show desired colors in the color layer (40), the saturation of the color is maximized and the expressive power is increased, and the color resolution of the color layer is increased and the pattern of the printing layer (50) can be more clearly identified.

Furthermore, in this case, the surface roughness of the color base layer (30) becomes smaller than that of the adhesive layer (20). Therefore, when the color layer (40) or the printing layer (50) is applied directly to the adhesive layer (20), the printing resolution is very low due to the surface roughness of the adhesive layer (20). However, when the color base layer (30) composed of the urethane film is first attached to the adhesive layer and then a color or pattern is printed on it, the printing resolution can be maximized. Accordingly, as the resolution increases along with the above-described increase in saturation, more microscopic patterns or shapes can be realized.

Furthermore, the color base layer (30) supports the color layer (40) when the color layer (40) is cured by the ultraviolet rays. That is, since the color base layer (30) has a permeability structure as described above, it is flexible and has significantly greater tensile strength than the adhesive layer (20). Therefore, even when the color layer (40) is cured, it is deformed in response to the change in volume of the color layer (40), thereby reducing cracks in the color layer and maintaining the bonding force with the adhesive layer (20) on the other side, and the durability of the gel nail (100) is significantly increased.

The color layer (40) is coated on the color base layer (30) and may be formed by printing color ink to a certain thickness. The color inks used in the color layer (40) include CMYK, etc., where C is blue, M is red, Y is yellow, and K is black, and these color inks can be used alone or mixed appropriately to form the color layer (40).

In this case, a very small amount of light stabilizer is added to the general color layer (40) to prevent the phenomenon of rapid curing due to external ultraviolet rays, fluorescent lamps, and indirect ultraviolet rays such as LEDs, etc., but the adhesive gel nail (100) according to this embodiment has durability secured by the color base layer (30) described above, so the production cost can be significantly reduced by not using the light stabilizer.

The printing layer (50) generally refers to printing a nail shape pattern, and the printing layer (50) refers to the design expressed by various printing methods or gold foil, silver foil, hollow foil, or glitter (glitter). In this case, the printing layer (50) can be formed by methods such as silk screen printing, flexographic printing, offset printing, digital printing, and gravure printing.

Meanwhile, the gel coating layer (60) includes a UV gel coating layer (61) and an LED gel coating layer (65).

The UV gel coating layer (61) is applied to the color layer (40) or the printing layer (50), and can be formed by applying a UV gel coating solution mixed with oligomers, monomers, and short wavelength initiators and drying it using an ultraviolet curing method. For example, the UV gel coating layer (61) can be formed using a UV gel coating solution mixed with 40% to 60% oligomer, 30% to 55% monomer, and 2% to 10% short wavelength initiator. In this case, urethane, acrylic, acrylepoxy, polyester-based oligomers, etc. may be used as the oligomer, and TPO, 184, etc. may be used as the short wavelength initiator. Also, the UV gel coating layer (61) may be formed by drying the applied UV gel coating solution in a UV curing method.

In the case of this UV gel coating layer (61), the gel nail 100 becomes too flexible (soft) when the oligomer content exceeds the standard value (that is, when the content of the oligomer exceeds 60%), and the gel nail may be deformed. In addition, scratches, dents, etc. may cause a lot of damage, which may reduce the holding power. Therefore, it is necessary to mix so that the content of oligomers does not exceed 60% as much as possible.

Meanwhile, when the oligomer content is less than the standard value (that is, when the content of the oligomer is less than 40%), the gel nail (100) becomes too hard to attach to the curved nails of general consumers. Therefore, the gel nail (100) may be detached (a phenomenon that the nail or toenail falls off) due to a lack of adhesion, and deformation may occur because there is no sense of adhesion. Therefore, it is preferable to mix so that the oligomer content is 40% or more.

On the other hand, if the monomer in the UV gel coating layer (61) exceeds the standard value (e.g., 55% content), the flexibility and elongation of the product may decrease, and the adhesion (adhesiveness) attached to the curved fingernail or toenail decreases, so the durability this may deteriorate. Meanwhile, if the content of the monomer is less than the standard value (e.g., 30%), the gel nail (100) becomes too hard, so when attached to the curved nail, the adhesion (adhesiveness) decreases, and the durability (adhesion to the fingernail or toenail) becomes low, it is preferable to mix the monomers in the range of 30% to 55%.

Here, the adhesion to the fingernail or toenail means that the lower adhesive layer (not illustrated) provided in the base film (10) in the gel nail (100) does not fall off and is attached to the user's curved fingernail or toenail. By improving the adhesion of the lower adhesive layer, the adhesive gel nail (100) can have excellent adhesion to the fingernail or toenail.

Also, if the short wavelength initiator exceeds 10% in the UV gel coating layer (61), the curing state of the product becomes too fast, and natural curing may occur during the manufacturing or distribution process, so it becomes difficult to attach the gel nail (100) to the user's curved nail or toenail, and even if it is applied, the gel nail (100) can be easily removed from the nail or toenail. In order to prevent this phenomenon, in the case of the UV gel coating layer (61), the short wavelength initiator may be mixed so as not to exceed 10%.

On the other hand, when the amount of the short wavelength initiator is less than the standard value (e.g., 2%), the curing speed may decrease and the product may have poor durability. As a result, foreign matters may easily adhere to the fingernail or toenail, deformation may easily occur, and durability may also be reduced. Therefore, it is preferable to adjust the content of the short wavelength initiator used in the UV gel coating layer (61) to be 2% or more.

The LED gel coating layer (65) is applied on the UV gel coating layer (61), and may be formed by applying and drying an LED gel coating solution in which an oligomer, a monomer, a long-wavelength initiator, and cellulose are mixed. For example, the LED gel coating layer (65) can be formed using an LED gel coating liquid mixed with 15% to 40% oligomer, 20% to 30% monomer, 0.1% to 0.5% long wavelength initiator, and 30% to 55% cellulose. Also, the applied LED gel coating solution may be dried between 60 degrees and 100 degrees for about 30 minutes to 60 minutes to form the LED gel coating layer (65). As such, the UV gel coating layer (61) and the LED gel coating layer (65) may serve to protect the printing layer (50) as transparent coating layers. For example, the LED gel coating layer (65) may have a thickness of 220 microns.

In the case of the LED gel coating layer (65), if the monomer content exceeds the standard value (e.g., 30%), the stickiness of the gel nail (100) may intensify and the hardness may decrease. Also, the gel nail (100) may come into contact with the user's hand and the shape of the gel nail (100) may be damaged. The curing speed of the product is also greatly reduced. In order to prevent this phenomenon, it is preferable to adjust the content of the monomer to 30% or less in the LED gel coating layer (65). On the other hand, if the content of the monomer is less than 20%, the gel nail (100) becomes too hard, and when the gel nail (100) is attached to the curved nail, the adhesion may decrease and the durability may also be reduced. Therefore, it is preferable to make the content of monomers 20% or more.

On the other hand, if the oligomer contained in the LED gel coating layer (65) exceeds 40%, it can be easily cured by the ultraviolet rays. That is, the natural curing may easily occur during the manufacturing or distribution process of the gel nail (100). For this reason, when the user removes the gel nail (100) after the LED gel coating layer (65) is cured, it cannot be completely removed and may be split and peeled off. In this case, damage to the nails may occur. Meanwhile, if the oligomer is less than 15%, the curing speed during UV curing is too slow, and the curing cannot be completed completely, and if an uncured product is used in this state, the gel nail (100) may be severely damaged. As such, the durability of the gel nail (100) may decrease due to shape deformation, gloss reduction, foreign matter, and the like.

Also, if the long-wavelength initiator of the LED gel coating layer (65) exceeds 0.5%, the natural curing may easily occur due to exposure to light in real life, making it difficult to easily attach the gel nail (100) to the user's curved nail or toenail, even after attaching, the gel nail (100) may easily fall off. If the long-wavelength initiator is less than 0.1%, the curing speed may be too slow and the hardness of the gel nail (100) may deteriorate. As a result, the foreign matters are easily attached, deformation easily occurs, and durability may be reduced.

Also, if the cellulose content of the LED gel coating layer (65) is mixed to exceed 55%, the elongation of the gel nail (100) is too low, making it difficult to attach it to the curved nail or toenail. That is, since the gel nail (100) is not completely adhered to the user's fingernail or toenail and easily falls off, the adhesive strength and durability of the gel nail (100) may decrease. Therefore, it is preferable to mix the cellulose to be 55% or less in the LED gel coating layer (65). Meanwhile, if the content of cellulose is less than 30%, the function of making the gel nail 100 in a semi-solid state may deteriorate, so the cellulose content needs to be 30% or more.

Meanwhile, the monomer, oligomer, and long-wavelength initiator used in the adhesive gel nail (100) according to one embodiment of the present invention are all products in a liquid state, and change from a liquid state to a solid only when exposed to the ultraviolet rays. In this case, the cellulose can perform the function of making the liquid gel nail into a semi-solid state.

Also, the adhesive gel nail (100) according to one embodiment of the present invention can be configured to cut the adhesive layer (20), the color base layer (30), the color layer (40), and the UV gel coating layer (61), and the LED gel coating layer (65) formed on the base film (10) by a punching process to form the fingernail or toenail. After this punching process, a cutting process of cutting up to the base film (10) to create an adhesive gel nail may be further performed.

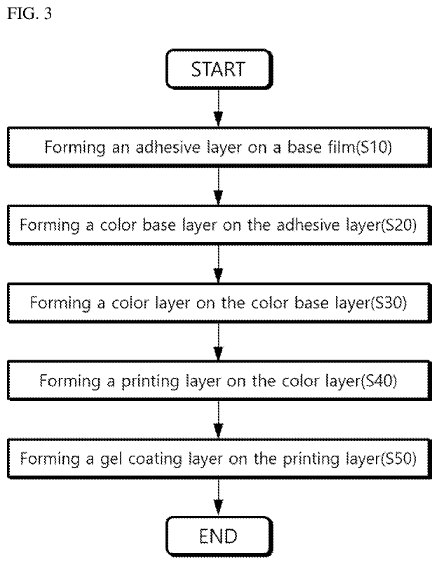

Hereinafter, the method for manufacturing the adhesive gel nail according to one embodiment of the present invention will be described. FIG. 3 is a flowchart illustrating the method of manufacturing the adhesive gel nail according to one embodiment of the present invention.

Referring to the drawings, the method of manufacturing the adhesive gel nail according to the present embodiment includes the step of forming the adhesive layer on the base film (S10), forming the color base layer on the adhesive layer (S20), the step of forming the color layer on the color base layer (S30), the step of forming the printing layer on the color layer (S40), and the step of forming the gel coating layer on the printing layer.

In this case, the explanation that overlaps with the previous one is omitted, and in this embodiment, it is most important to form the color base layer on the adhesive layer. In this case, unlike the case where the color layer is formed on the lower part after applying the gel coating layer, in this embodiment, the adhesive layer is formed first and then the color layer is formed on the top thereof, so the curing of the color layer is a major disadvantage that causes cracks. Therefore, since the white series acts as a color base, the surface roughness becomes smaller than the adhesive layer, the color base layer closely supports the color layer even when the color layer hardens while increasing the printing resolution, thereby significantly increasing the durability of the color layer and the entire gel nail.

As above, the preferred embodiments of the present invention are disclosed in the specification and drawings of the present invention, and although specific terms are used, they are only used in a general sense to easily explain the technical contents of the present invention and help understand the present invention, and are not intended to limit the scope of the present invention. In addition to the embodiments disclosed herein, it is obvious to a person skilled in the art that other modified embodiments based on the technical ideas of the present invention can be implemented.

### DESCRIPTION OF REFERENCE NUMERALS

100: adhesive gel nail

10: base film

20: adhesive layer

30: color base layer

40: color layer

50: printing layer

60: gel coating layer

61: UV gel coating layer

65: LED gel coating layer

70: protective film

1. An adhesive gel nail, comprising:
an adhesive layer;
a color base layer formed on the top of the adhesive layer; and
a color layer formed on the top of the color base layer.

2. The adhesive gel nail of claim 1, wherein the color base layer is formed of a urethane material.

3. The adhesive gel nail of claim 2, wherein an air hole is formed in the color base layer.

4. The adhesive gel nail of claim 3, wherein the color base layer is formed in a mixed structure of open cell and closed cell.

5. The adhesive gel nail of claim 1, wherein the surface roughness of the color base layer is smaller than the surface roughness of the adhesive layer.

6. The adhesive gel nail of claim 1, wherein the adhesive layer contains at least one of vitamins, calcium, eucalyptus, cypress water and natural herbs.

7. The adhesive gel nail of claim 1, wherein the color layer is cured by ultraviolet rays while in contact with the color base layer.

8. The adhesive gel nail of claim 1, Further comprising a gel coating layer formed on the color layer, wherein the gel coating layer comprises a UV gel coating layer and an LED gel coating layer.

9. A method for manufacturing the adhesive gel nail, comprising:
forming the adhesive layer;
forming the color base layer on the adhesive layer; and
forming the color layer on the color base layer.

10. The method for manufacturing the adhesive gel nail of claim 9, wherein in the step of forming the color base layer, a urethane film having a surface roughness smaller than that of the adhesive layer is attached to the adhesive layer.
